(19) United States
(12) Patent Application Publication
(10) Pub. No.: US 2022/0228760 A1
(43) Pub. Date: Jul. 21, 2022

(54) Pump-Assisted, Ground Source, Heat Pipe System for Heating and Cooling Water, Greenhouses and Buildings

(71) Applicant: Exotherm, Inc., Houston, TX (US)

(72) Inventors: Michael J. Parrella, Katy, TX (US); Nevil R. Ede, Westport, CT (US); Martin A. Shimko, Quechee, VT (US)

(21) Appl. No.: 17/607,170

(22) PCT Filed: Dec. 16, 2019
(86) PCT No.: PCT/US2019/066580

§ 371 Date: Oct. 28, 2021

Related U.S. Application Data
(60) Provisional application No. 62/779,781, filed on Dec. 14, 2018.

(51) Int. Cl. F24F 5/00; F24D 15/04

(52) U.S. Cl. CPC F24F 5/0046; F24F 2005/0057; F24D 15/04

(57) ABSTRACT

A looped, pump assisted heat pipe system is provided including an underground well bore providing a vertical distance between an evaporator and a condenser of the system. The system includes a fluid loop with a circulating fluid, an evaporator arranged in the fluid loop configured to evaporate circulating fluid in a liquid state to a vapor and a condenser arranged in the fluid loop in the underground well bore configured to condense the vapor into the liquid state. A pump can be arranged at the base of the well bore, in the fluid loop between the condenser and the evaporator configured to pump circulating fluid in the liquid state to the evaporator. The system can be used in heating or cooling air for buildings and structures and water sources.

### CROSS-REFERENCE TO RELATED APPLICATIONS

The present application claims the benefit of U.S. Provisional Application No. 62/779,781 filed Dec. 14, 2018, which is hereby incorporated by reference in its entirety.

### BACKGROUND OF THE INVENTION

Previously, ground source heating and cooling systems have only been used utilizing conventional compressor driven heat pump configurations. This is usually addressed by circulating liquid underground and sensible heat loss (for a cooling application) to the cooler ground. Fairly large flow rates and extensive surface area, usually accomplished by buried loops of tubing, are required to achieve significant heat transfer.

A few applications have circulated refrigerants in buried tubing, making the ground loop operate similar to a conventional condenser in a refrigerant to air configuration. These systems have demonstrated the viability of direct condenser operation in buried ground. Heat transfer rates are greatly increased when the buried condenser is in a subterranean aquifer, commonly used for ground water extraction in well configurations. The operating efficiency (reduced compressor power draw) comes from the decreased temperature of the system heat sink relative to ambient air temperature when they drop below the deep soil temperature. But the increased efficiency is limited to an incremental increase in the cycle efficiency of the overall heat pump cycle operation and rarely compensates for the cost of installing the underground condenser.

But in many cases, especially for cooling, the ground temperature several feet (or as far as 1000 feet) below the surface is constant and below the ambient temperature (or above the ambient temperature for heating) in a magnitude useful for direct heat pipe application to handle or significantly offset the cooling (or heating) loads. Heat pipes use evaporating and condensing processes at opposing ends of a simple open tube. They work in the direction of the thermal gradient, unlike heat pumps which go against the thermal gradient. FIG. 1 shows a typical heat pipe configuration and process.

Heat pipes, which are commonly used in computer and aerospace cooling applications, can be adapted to larger-scale, near-ambient temperature applications. Performance demonstrations at the kW scale, diameters to 2 inches and lengths to 60 feet have already been demonstrated for various high power applications. In these cases, the evaporator component is physically located below the condenser.

In a conventional heat pipe, if the heat absorption end (i.e., the evaporator) is higher than the heat dissipation end (i.e., the condenser), the upward return liquid flow is driven by capillary forces in a wicking process (porous material or small dimensional grooving). This is effective in cases where the transport length or height differential is limited to a few feet before significant heat flow rate reduction and eventual non-operation occur.

To increase the distance and height to which heat pipes can be applied an arrangement known as a looped heat pipe can be used. This arrangement is shown in FIG. 2 and was the subject of U.S. Pat. No. 4,515,209. This system 10 uses separate lines for the vapor 17 and liquid flows to the condenser 11, and evaporator 12, and incorporates a condensation chamber called an isolator 15 and a custom designed wicking system 16 in the evaporator 12. This greatly increases the distance between the evaporator 12 and condenser 11 that can effectively be addressed, but does not significantly affect the height difference between the components that can achieved. The system 10 may also include a sub-cooler 13, a liquid reservoir 14 and liquid slugs 18.

For a ground source cooling application using a below grade condenser location, the possible lift from wicked designs is insufficient, since the height between an above ground evaporator and stable below grade sink temperatures are generally at depths greater than ten feet. This is especially true when accessing aquifers that take advantage of the superior heat transfer characteristics that significantly increase the heat carrying capacity of a given condenser design over damp or wet ground conditions. Depths of 200 feet or more are frequently required to access these highly effective heat sinks.

### SUMMARY OF THE INVENTION

To address these limitations, the present application provides for a pump assisted or pump driven looped heat pipe design that can be used to lift the return liquid from the underground condenser to the above ground evaporator. This design has been suggested for use in data centers to allow long, multi-channeled distribution loops, but has never been conceived of to address the lift pressure needed to apply looped heat pipes to significant vertical height difference applications.

The addition of the pump allows the vertical distance to be almost arbitrarily long. The sizing of the vapor and liquid lines is set by the required flow rates and maintaining very low pressure loss along the length that has a negative effect on performance and therefore capacity. Another advantage is that the pump and flow control valve used in the system eliminates the need for a compensator and, most importantly, the wicking arrangement in the evaporator. Conventional evaporator designs (whether air-to-refrigerant or water-to-refrigerant) can be efficiently used and yield a large cost savings. The pumping power for moving the incompressible fluid up to the evaporator is minimal.

Deep underground heat sink applications have an additional advantage of an inherent increased condenser pressure and temperature relative to the evaporator operation. This increases the available ΔT for the combined evaporating and condensing operations. This is due to the pressure head of the vapor column in the section between the evaporator and condenser. As an example, for a refrigerant fluid such as R32 at near ambient temperatures (˜200 psi vapor pressure) at 400 feet depth, this increases the condenser pressure by 7.3 psi, with the accompanying gain of 1½° F. in temperature. The power input typically seen in a compressor to achieve this pressure increase is reduced by approximately 90% since the evaporator pressure is maintained by the return pump via incompressible pressurization.

It is also impractical to install and operate long lengths of conventional small diameter tubing normally used in ground sink (or source) systems at these depths. To address this, a larger-diameter, coaxially-nested arrangement with the small diameter liquid return line located inside a larger diameter vapor line is used. The bottom of the outer casing is sealed at the bottom. The bottom of the casing area will act as a reservoir appropriately sized to allow operation through a range of temperature and load conditions.

The present application relates to a novel approach to applying a looped heat pipe to applications where there exists a significant vertical distance between the higher evaporator and the lower condenser ends of the system. This is critical in addressing ground sink (and source) systems as they apply to building, greenhouse, and water cooling (and heating). By using a liquid pump located near the vertically lowest point in the system immediately after the condenser section, flow can be maintained in the looped heat pipe against an arbitrarily high pressure due to gravity head or any other phenomena. With appropriate underground heat sink (or source) temperatures, significant cooling (and heating) can be delivered with very small energy use. While heat pipes have traditionally been viewed as passive (i.e., requiring no mechanical energy use) systems for transporting heat, the pump-assisted, heat pipe system of the present application effectively replaces the compressor normally found in in vapor compression based A/C and heat pump systems with a liquid pump. The near incompressible pumping of the refrigerant around the loop reduces energy usage by up to 90% in common applications.

The benefits of this cooling and heating system are described herein, including several performance advantages inherent in the vertically oriented configuration and significant vertical depths involved, several construction techniques and configurations that have both cost reduction and performance enhancing benefits, and the stand-alone operation and integration into existing cooling systems, as well as an innovative “hybrid” design that works as a heat pipe and heat pump in both cooling and heating applications. The system of the present invention provides several advantages, including but not limited to the following:

Only one hole needs to be drilled for system implementation. Depending on the system capacity, application, and heat sink temperature, the hole diameter can range up to several inches. Because this is a condensing heat exchanger the large diameter does not lower the overall heat transfer coefficient appreciably. This size is also typical of many water well installations.

A large condenser surface area per vertical length is provided by the system of the present application. The surface area in the condenser section will determine how much of the available temperature difference between the sink and source temperatures is needed in the condenser. For example, 200 feet of this pipe has sufficient surface area and heat exchange potential to support a five ton cooling system when engaging a typical aquifer. Average temperature differences in the range of 3° F. are needed to achieve the required refrigerant condensation rate.

The system also allows installation of the seals, pumps and liquid return line after completion of a simple cased well. The initial well boring will essentially be the same as a standard open bottom water well. Practical approaches to drilling and casing the well bore during drilling can be implemented because the pump and return line are contained completely inside the casing/condenser housing. After completion and casing of the well, a bottom seal can be installed. The pump and return line assembly can be lowered in after that.

The well casing also serves as the vapor transport tubing and condenser surfaces. The casing segment connections will need to be vapor tight to implement the initial vacuum and refrigerant filling process, as well as to reduce any refrigerant leakage to acceptable levels. The materials for the high heat transfer condenser section (when the well has reached the aquifer or appropriately cold depths) is selected to enhance heat transfer, while the casing in the upper regions nearer the surface or above the aquafer will be made from less expensive materials and the insulative nature of the material preventing heat transfer is integral to this application.

The coaxial configuration also allows the refrigerant pump to be easily removed for maintenance or replacement by pulling it to the surface by the liquid return line to which it is attached.

It is advantageous to insulate the liquid return line to avoid collecting heat prior to arrival at the evaporator unit. It is critical to cycle efficiency to limit the temperature gain in the liquid refrigerant return line on its way to the evaporator on the surface. Refrigerant flow rates for five tons of cooling are low and allow one inch or less tubing to be used for this line. Insulation can easily be added to the return line (increasing the outer diameter) as there is more than sufficient flow area in the outer casing to transport the vapor down to the condenser with very low pressure drops. This is also critical in maintaining the increased condenser operating pressure created by the fluid head.

Horizontally oriented condensers can suffer from slug flow and vapor lock which can retard or disable system capacity and functionality. Because the system is inherently vertically oriented and the liquid flow rates are low relative to the flow and surface area of the casing, the condensing fluid will tend to stream along the sides and not create a liquid block in the passage or fluid film on the inside surface. In fact, the reality is that a “vertical” well will almost always have some slight angle away from vertical. This actually assists in the forming of downward liquid stream

The condenser piping size is large enough to provide an adequately sized liquid refrigerant reservoir for stable operation through a range of temperatures and cooling (or heating) rates.

The system can easily be adapted to ground source heating or heat pump assistance. The system will naturally circulate when the condenser is above the evaporator (as referenced above). To be operated efficiently in this reverse flow process, there needs to be a bypass around the liquid return line and liquid pump so that liquid from the above grade condenser is free to flow down the larger outer tube. This tube also acts as the vapor transport tube upward to the condenser just like in a conventional heat pipe. Design considerations in the evaporator (during cooling operation) need to be implemented to be used as an effective condenser while in the heating mode. This design tradeoff is routinely done in existing heat pump systems that are used for both cooling and heating.

In accordance with the present application, a pump-assisted heat pipe system is provided. The system comprises a fluid loop comprising a fluid circulating through piping; an evaporator arranged in the fluid loop configured to evaporate circulating fluid in a liquid state to a vapor; a condenser arranged in the fluid loop configured to condense the vapor into the liquid state; and a pump arranged in the fluid loop between the condenser and the evaporator configured to pump circulating fluid in the liquid state to the evaporator.

In accordance with an embodiment of the system of the present application, the system further comprises an underground well bore, wherein the pump is arranged substantially at the bottom of the underground well bore. The evaporator of the system can be arranged above ground outside of the underground well bore. Further in this embodiment, the fluid loop piping may comprise one or more upward flowing pipes in the underground well bore delivering fluid from the pump, and one or more downward flowing pipes in the underground well bore receiving the vapor from the evaporator, wherein the condenser is formed by the one or more downward flowing pipes in the underground well bore, and the vapor releases heat to the ground around the underground well bore and condenses into the liquid state. The system may further comprise a fluid reservoir at the bottom of the underground well bore configured to receive the fluid in the liquid state. In certain embodiments, the underground well bore has a depth between 200 and 1,000 feet.

In accordance with a further embodiment of the system of the present application, which may be in addition to or alternative to the above-described embodiment, the system further comprises an incoming air flow provided to the evaporator, wherein the evaporator is configured to absorb heat from the incoming air flow and provide a cooler, outgoing air flow. In one such embodiment, the system further comprises an air conditioning system evaporator; wherein the system evaporator is positioned in between the air conditioning system evaporator and the incoming air flow to the air conditioning system evaporator and the evaporator is configured to provide the cooler outgoing air flow to the air conditioning system evaporator. In an additional or alternative such embodiment, the system further comprises an air conditioning system condenser, wherein the evaporator is positioned in between the air conditioning system condenser and the incoming air flow to the air conditioning system condenser and the evaporator is configured to provide the cooler outgoing air flow to the air conditioning system condenser.

In accordance with a still further embodiment of the system of the present application, which may be in addition to or alternative to the above-described embodiments, the system further comprises a flow control valve positioned in the fluid loop in between the pump and the evaporator configured to control flow of the fluid in the liquid state to the evaporator.

In accordance with a still further embodiment of the system of the present application, which may be in addition to or alternative to the above-described embodiments, the system further comprises a compressor positioned in the fluid loop in a flow path from the evaporator and the condenser. The compressor can be arranged above ground outside of the underground well bore. The compressor may also be configured to be turned on or off to alternate between operation modes using the compressor and not using the compressor.

In accordance with a still further embodiment of the system of the present application, which may be in addition to or alternative to the above-described embodiments, the system is configured to reduce the temperature of a water source.

In accordance with a further embodiment of the system of the present application, the system further comprises an underground well bore, and the condenser is arranged above ground outside of the underground well bore. In such embodiment, the fluid loop piping may comprise one or more upward flowing pipes in the underground well bore delivering vapor to the condenser, and one or more downward flowing pipes in the underground well bore receiving the fluid from the condenser, wherein the evaporator is formed by the one or more downward flowing pipes in the underground well bore, wherein the fluid absorbs heat from the ground around the underground well bore and evaporates into vapor. The system may further comprise an incoming air flow provided to the condenser, wherein the condenser is configured to release heat to the incoming air flow and provide a warmer, outgoing air flow. In a further embodiment, the system may further comprise a heating system condenser, wherein the condenser is positioned in between the heating system condenser and the incoming air flow to the heating system condenser, and wherein the condenser is configured to provide the warmer outgoing air flow to the heating system condenser. The system may additionally or alternatively comprise a heating system evaporator, wherein the condenser is positioned in between the heating system evaporator and the incoming air flow to heating system evaporator and wherein the condenser is configured to provide the warmer outgoing air flow to the heating system evaporator. In certain embodiments, the underground well bore has a depth between 200 and 1,000 feet.

In accordance with a still further embodiment of the system of the present application, which may be in addition to or alternative to the above-described embodiments, the fluid in the fluid loop is R32 refrigerant.

### BRIEF DESCRIPTION OF THE FIGURES

FIG. 1 shows an example of a heat pipe schematic according to the prior art;

FIG. 2 shows a conventional, looped heat pipe configuration according to the prior art;

FIG. 3 shows an exemplary diagram of a pump assisted, looped heat pipe system in accordance with the present application;

FIG. 4 shows a co-axial, single-bore, pump-assisted, looped heat pipe system in accordance with an embodiment of the present application;

FIG. 5 shows an integration of an evaporator from a pump-assisted heat pipe system of an embodiment of the present application into an existing air conditioning system;

FIG. 6a shows a graph of room temperature variation comparison according to an embodiment of the present application;

FIG. 6b shows a graph of compressor operation comparison according to an embodiment of the present application;

FIG. 7 shows an integration of an evaporator from a pump-assisted heat pipe of an embodiment of the present application with an existing cooling system condenser;

FIG. 8 shows a hybrid configuration of a pump-assisted heat pipe system of the present application;

FIG. 9 shows a basic configuration of an embodiment of a heat pipe system of the present application for heating integrated with an in-building condenser;

FIG. 10 shows a basic configuration of an embodiment of a heat pipe system of the present application for heating integrated with an in-building evaporator; and

FIG. 11 shows a hybrid system incorporated into a heat pipe system of the present application in heating mode.

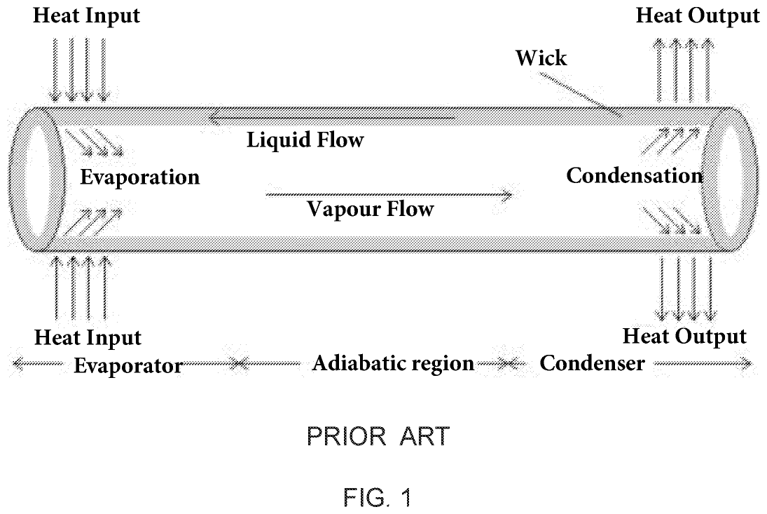

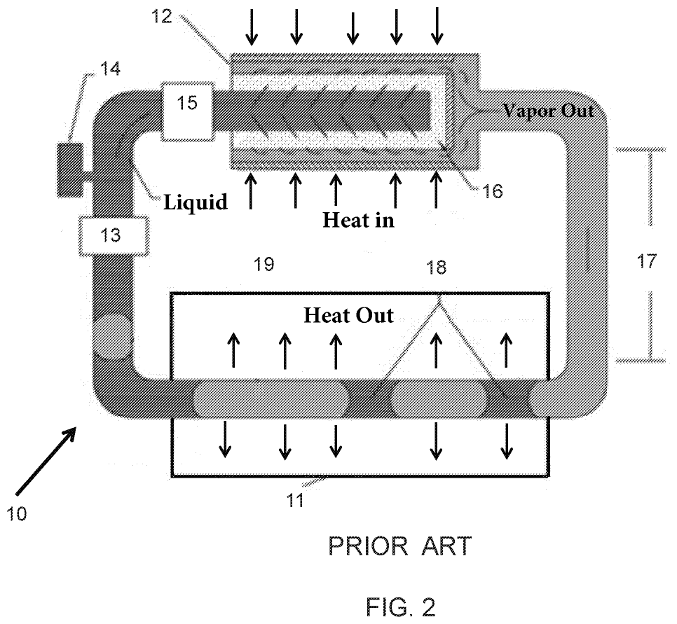

### DETAILED DESCRIPTION OF THE FIGURES

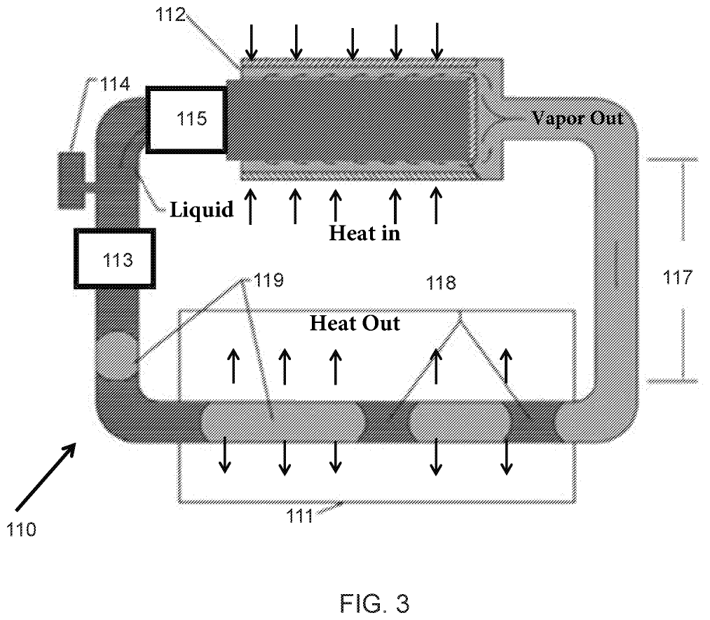

The present application will now be described with reference to FIGS. 3-11

A pump assisted, or pump driven, looped heat pipe system 110 is provided that can be used to lift return liquid from an underground condenser 111 to an above ground evaporator 112, an exemplary diagram of which is shown in FIG. 3.

In the pump assisted heat pipe system 110, liquid is circulated through the system 110. A reservoir 114 of liquid is provided, including for example at the bottom of the casing area, which can act as a reservoir appropriately sized to allow operation through a range of temperature and load conditions. In an exemplary embodiment, the pump 113 of the system 110 is placed at the bottom of a vertical, underground well, between an underground condenser 111 and an above-ground evaporator 112. The condensed liquid is pumped upwardly by the pump 113 through vertical well piping towards the evaporator 112. A flow control valve 115 can be positioned between the pump and the evaporator 112 to control flow of the liquid into the evaporator 112. Heat is absorbed by the liquid at the evaporator 112, which provides an output of saturated or superheated vapor 117. The vapor 117 is provided to the condenser 111, which may take the form of the downward flowing section of the piping in the vertical well. Heat is released to the ground from vapor 117 flowing through the condenser 111, as vapor bubbles 119 condense into liquid. Liquid slugs 118 may also be provided in the condenser system 111. When the condensed liquid reaches the bottom of the well, the pump 113 pumps the condensed liquid back to surface evaporator 112.

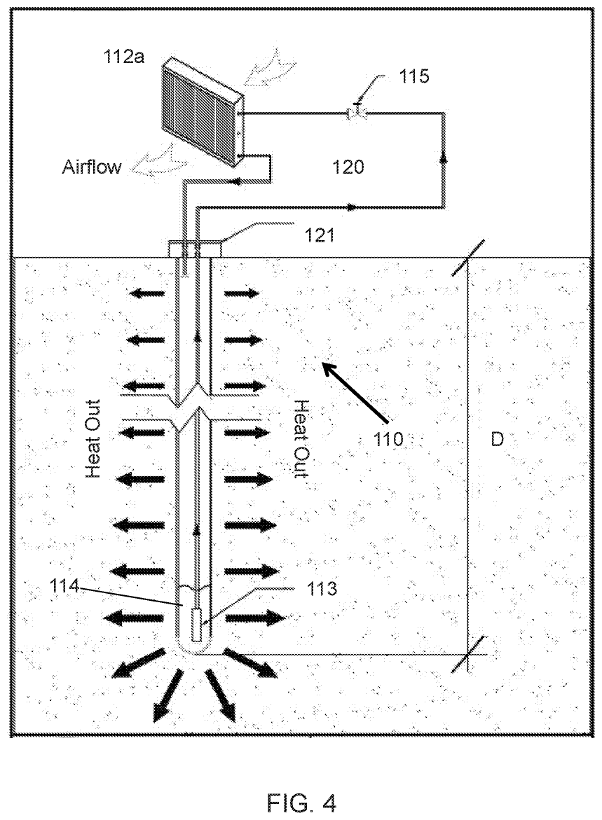

FIG. 4 shows a further example of a co-axial, single-bore, pump-assisted, looped heat pipe system 110 according to the present application. In the embodiment shown in FIG. 4, a loop 120 of a refrigerant fluid such as R32 is provided, which is at near ambient temperatures (about 200 psi vapor pressure) at 400 feet depth, which increases the condenser pressure by 7.3 psi, with the accompanying gain of 1½° F. in temperature. The pump 113 of the system 110 is placed underground at the bottom of a vertical well, and pumps cooled, condensed liquid through vertical well piping towards the surface to evaporator coils 112a. A pipe cap and seal 121 can be provided at the surface to cover the underground well and piping. In embodiments of the system 110, the pump 113 is placed at the bottom of the underground well having a depth (D) ranging between 200 to 1000 feet. A flow control valve 115 can be positioned between the pump and the evaporator 112 to control flow of the liquid into the evaporator 112. As previously described, heat is absorbed by the refrigerant at the evaporator 112, which outputs a heated vapor that is provided into the downward flowing piping of the underground well, which serves as a condenser 111, releasing heat from the vapor to the ground as the refrigerant condenses back into a liquid state. An additional warm air or liquid flow or source can be provided to the evaporator coils 112a, where the condensed liquid absorbs heat from the air or liquid, and a cooled air or liquid is output at the evaporator coils 112a.

The pump-assisted looped heat pipe system 110 can be retrofitted to be integrated into existing cooling and heating systems.

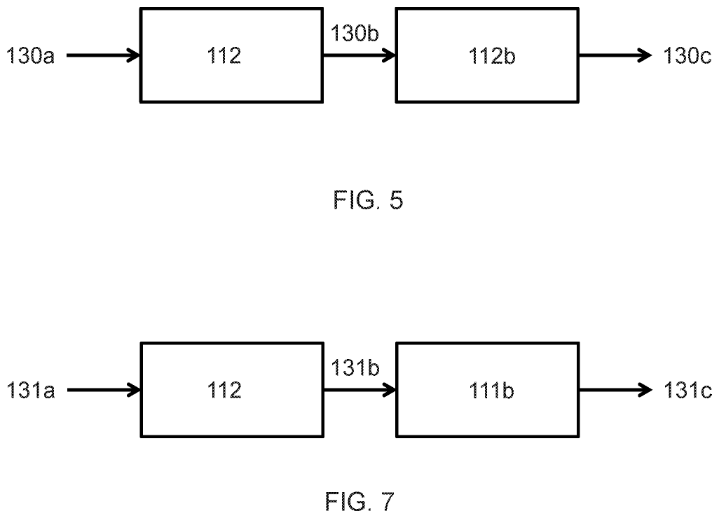

The pump assisted heat pipe system can be retrofitted into existing A/C cooling systems by precooling the air entering the existing system room air return line, as shown in FIG. 5. The evaporator 112 for the pump assisted heat pipe system 110 is placed in the room air return line ducting immediately before the existing system evaporator 112b. For ease of illustration, in FIGS. 5 and 7 only the evaporator 112 of the pump assisted heat pipe system 110 is shown, but the evaporator 112 shown in FIGS. 5 and 7 is arranged in a pump assisted heat pipe system 110 as illustrated for example in FIGS. 3-4. The evaporator 112 utilizes air from the room 130a in heating the condensed fluid provided through the evaporator 112. Heat is thus supplied from the room air 130a to the evaporator 112, thereby cooling the air so that an output of pre-cooled air 130b is provided to the existing system evaporator 112b, which outputs the air to the room 130c. This configuration is especially beneficial in applications where the heat sink temperature is insufficient for the pump-assisted heat pipe system 110 to supply the entire peak cooling load. When the required cooling is within the capability of the pump assisted heat pipe system 110, the cooled air 130b will just flow through the existing system evaporator 112b. When the load exceeds the capability of the heat pump system 110, the precooled air 130b from the heat pipe system evaporator 112 will enter the existing system evaporator 112b and be further cooled.

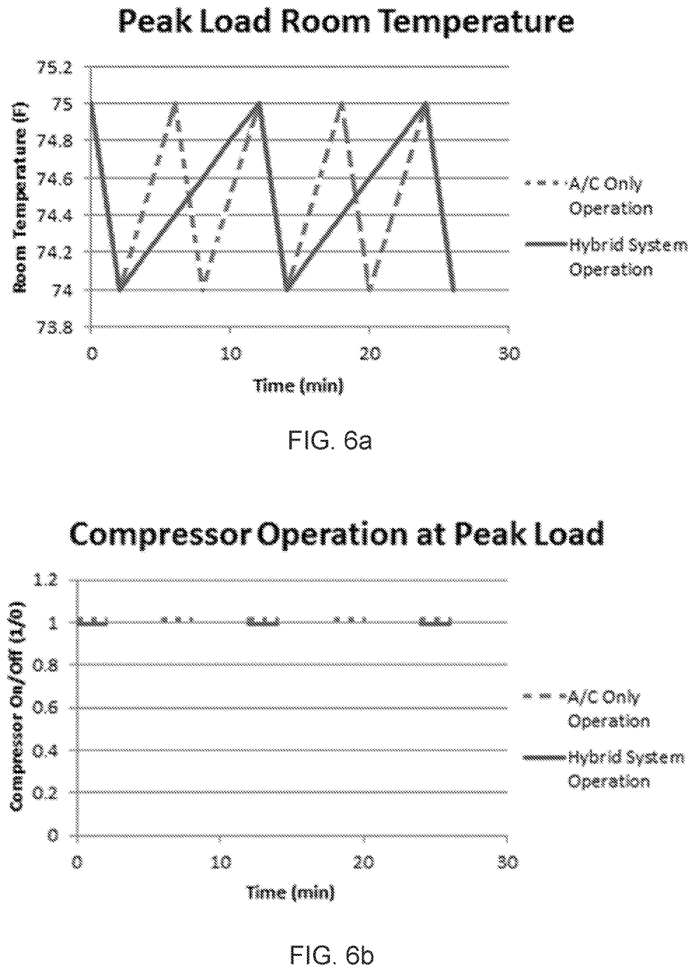

During periods of low cooling needs, the pump assisted heat pipe 110 can maintain the desired room (or water) temperatures, while at high cooling needs the heat pipe operation reduces the net heat gain to the house and essentially extends the time between compressor operation. This is shown in FIG. 6a and FIG. 6b for a case where the heat pipe carries half of the peak load. In this example, energy consumption is reduced by nearly 50% at peak times (and up to 90% as the load drops).

An alternative system comprising the pump assisted heat pipe system 110 includes utilizing evaporator 112 of the pump assisted heat pipe system 110 to precool the air entering the condenser 111b of an existing A/C cooling system, as shown in FIG. 7. This approach reduces the temperature of the existing system air side heat sink and raises the efficiency (COP) of the system. In normal hot environment conditions, this can save up to 20% in energy use. The evaporator 112 utilizes outside air 131a in heating the condensed fluid provided through the evaporator 112. Heat is thus supplied from the outside air 131a, cooling the air so that an output of pre-cooled outside air 131b is provided to the existing system condenser 111b, which outputs heated air 131c.

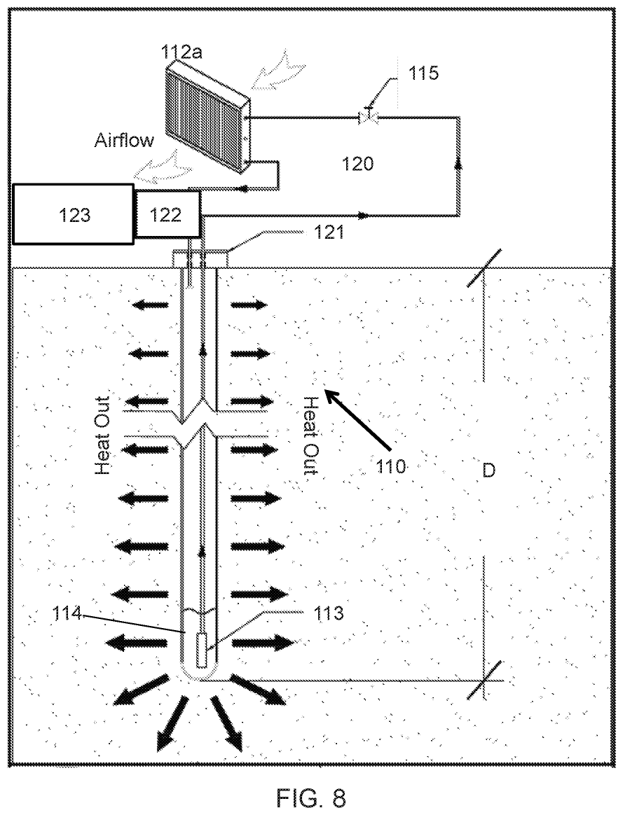

In a further embodiment, the pump assisted heat pipe system 110 can be reconfigured to be a stand-alone system in cases where the basic configuration does not supply the peak cooling loads, whether because of insufficient heat sink temperature or because the peak cooling loads are a small fraction of the “normal” load period and it is economically unattractive to size the basic system to cover this small window offer operation. In this hybrid configuration, a surface mounted compressor 123 is added to increase the condenser temperature beyond the natural pressure variation with depth, thus achieving higher cooling capacities. The compressor 123 is added in parallel with the vapor delivery line as shown in FIG. 8 and may comprise bypass valves 122. The system 110 can only be operated in open or compressed flow configurations separately. This essentially makes the pump assisted heat pipe system 110 a hybrid heat pump system. The compressor 123 can be used to raise the condenser pressure and saturation temperature, increasing the overall system ΔT and enabling increased heat transfer through the existing components. The liquid return pump 113 and flow control valve 115 can be operated to replicate the function of the expansion valve in a conventional heat pump (A/C or chiller) system. In addition, the pump/valve combination allows the evaporator 112a to be operated at a lower pressure and saturation temperature, enabling lower air or water delivery temperatures from the evaporator 112a. The advantage of the stand-alone hybrid system comes in the reduction of the number of the components as only one evaporator and one condenser are needed.

The system 110 can be operated by switching between the more energy intensive heat pump mode using the compressor 123 for higher cooling delivery (lower product delivery temperature) and the low energy consumption pump-assisted heat pipe mode that will essentially increase the time between compressor operation during periods of high cooling need. At low cooling needs the pump assisted heat pipe system 110 can maintain the desired room (or water) temperatures, while at high cooling needs the heat pipe operation reduces the net heat gain to the house and essentially extends the time between compressor operation in exactly the same way as the evaporator precooling integration described above.

An additional benefit of the hybrid design is that it increases the effectiveness of the heating application by operating the system as a conventional ground source heat pump without the addition of any further heat exchange components.

The pump assisted heat pipe system 110 of the present application can also be used in cooling applications, such as in buildings, warehouses or green houses.

A main distinction of the cooling application in a typical building, as compared to a warehouse or greenhouse application, is that the cooling air is distributed and turbulently mixed with the room air to give a relatively uniform temperature from floor to ceiling. In residential applications, a portion of the room air is directed to the cooling system evaporator and cooled before being redistributed to the building rooms. Refresh air needed to maintain a healthy room environment comes from naturally occurring outside air infiltration. This air infiltration adds to the required cooling load on the building when the outside temperature exceeds the room temperature. Nationally this load averages about 20% of the cooling requirement on an annual basis.

In larger commercial buildings, the relative amount of infiltration air is lower, therefore a portion of the room air is vented to the outside and outside fresh air is ducted in. In most larger installations, an energy recovery ventilation system is used to precool the incoming fresh air using the outgoing room vent air.

In both cases, the air entering the pump assisted heat pipe system 110 will be near or only slightly higher than the average room temperature. This is a primary parameter determining the cooling capability of the pump assisted heat pipe system 110 for a given set of heat exchanger components. A design/cost optimization analysis will determine the highest practical cooling load that can be supplied by the system.

In warehouses or greenhouses, which have higher ceilings and larger room volumes, there is frequently a significant temperature gradient between the floor level (work or plant level) and the ceiling. In these situations there is a significant benefit to pulling the recycled air from the ceiling area to take advantage of the increased temperature difference between this air and the underground heat sink. Even if energy recovery ventilation equipment is used (infrequently in warehouses and almost never in greenhouses) the inlet air to the evaporator will be 5 to 20° F. higher than the floor level temperature. Cooled room air is distributed at the floor level in such a manner that the naturally temperature gradient of the room is not appreciably disrupted.

For these applications, there is a much higher likelihood that the pump assisted heat pipe system 110 can be economically designed to cover the entire cooling load. In the case of greenhouses, this is even easier as a several degree increase in temperature at peak load times is acceptable. For these applications the reduction in power is maximized (1 kW per ton for a conventional system versus 100 W or less from the heat pipe system).

The pump assisted heat pipe system 110 can also be directly used in warmer climates for water cooling for greenhouses and buildings, and for cooling swimming pools. Average temperatures in a large portion of this region exceed 80° F. for the entire year.

In equatorial locations, the average water temperature near the surface or stored at the surface is too warm for use in greenhouses and is unappealing for use as drinking water. Optimum temperature for greenhouse water application is 78° F. or lower. Even lower temperatures are desirable for drinking water. Cooling and maintaining this large volume of stored water at temperatures significantly below the ambient air temperature is extremely energy intensive using standard vapor compression systems. The pump assisted heat pipe system 110 can lower stored water temperatures to near heat sink temperature with very low energy use, absorbing heat from warm water as previously described with respect to warm air.

Swimming pools located in these regions also require significant cooling to maintain the pool temperature at the desired range around 82° F. Swimming pools are strongly susceptible to overheating because of the large solar insolation load during the peak sunlight periods because clear bodies of water act like black body radiation absorbers. With no cooler overnight temperatures like those found in more temperate regions, the average pool temperature quickly rises well above the desired levels. The deep water temperatures found in many areas in this region are easily sufficient to maintain the desired water temperatures using the pump assisted heat pipe system 110 as a stand-alone system.

As described above, the pump assisted heat pipe system 110 can also be operated in reverse for ground source heating applications. In this mode, it operates like a standard heat pipe and does not use the liquid return pump 113 because the condensed refrigerant will flow naturally to the below ground evaporator 112 due to gravity and density difference with the vapor phase.

In a basic operation configuration, stand-alone operation of the system 110 as a heat pipe will allow heating of water or air to temperatures near the ground source temperature. This is directly applicable in freeze protection applications where the heat pipe system will warm circulating air or water and prevent temperatures forming below freezing.

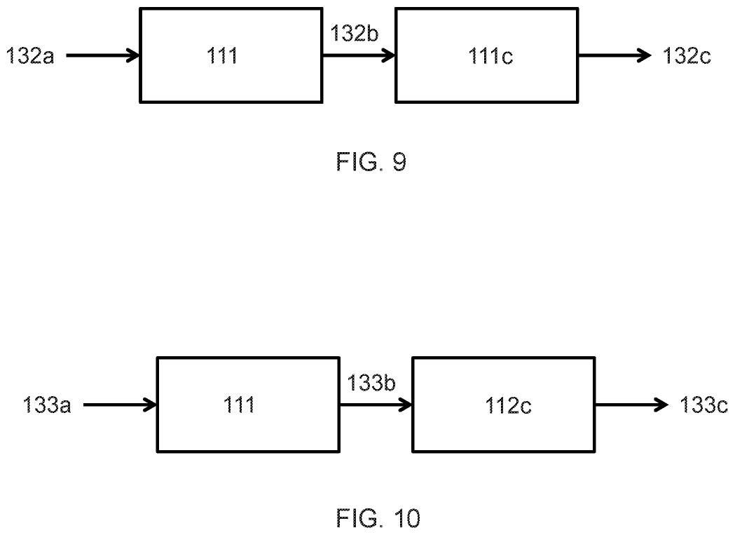

For warmer temperature air requirements, it can be applied to existing heat pump systems in two ways, similar to the cooling integration described and shown earlier with respect to FIGS. 5 and 7. For ease of illustration, in FIGS. 9 and 10 only the condenser 111 of the pump assisted heat pipe system 110 is shown. If outside air 132a at lower temperatures is being utilized by an existing ventilation and heating system, the heat pipe system can effectively preheat this air 132a and significantly reduce the energy consumption of the existing system. This arrangement is shown in FIG. 9. Cooler outside air 132a is heated by the condenser 111 of the system 110, which is above ground in this embodiment, to provide pre-warmed air 132b to an existing heating system condenser 111c, which outputs heated room air 132c.

If the existing system has effective energy recovery systems preheating the incoming air, this integration will be less effective and have a marginal impact on heating load. In that case, the integration can be effective if the existing building is using a heat pump heating system, as shown in FIG. 10. The heat pipe system condenser 111 can pre-warm the outside air 133a going to a heat source evaporator unit 112c located outside the building. Pre-heated outside air 133b is provided to the evaporator unit 112c, which provides cooled air 133c. In extremely cold conditions, this can have a significant beneficial effect on efficiency of the existing system (up to 50% at temperatures below freezing).

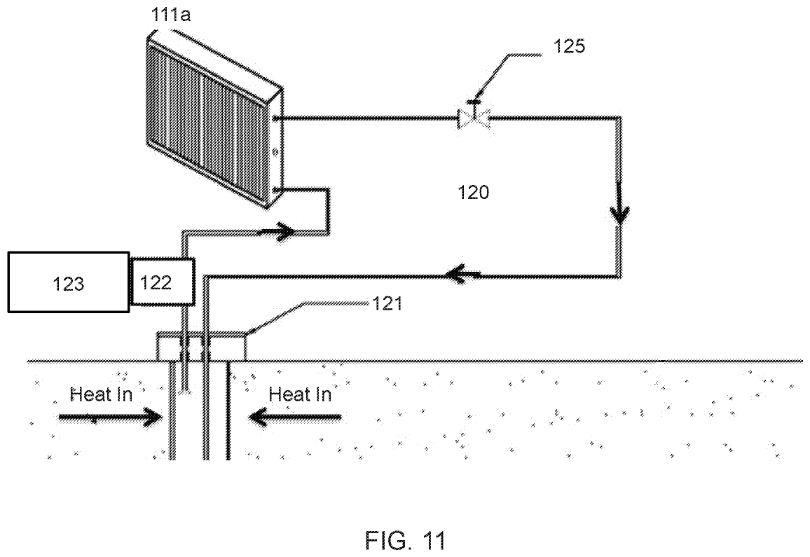

The hybrid design described above can be applied to heating application in the exact same manner as a standard ground source heat pump system. An example of this arrangement is shown in FIG. 11. The compressor 123 is turned off and on as needed to meet the heating demand. The compressor bypass valving 122 is configured so that the flow direction pushes vapor up the tubing toward the indoor condensing unit 111a. Cooled fluid is provided from the condenser 111a through an expansion valve of metered orifice 125, to the underground evaporator.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale or orientation.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

1. A system comprising:
a fluid loop comprising a fluid circulating through piping;
an evaporator arranged in the fluid loop configured to evaporate circulating fluid in a liquid state to a vapor;
a condenser arranged in the fluid loop configured to condense the vapor into the liquid state; and
a pump arranged in the fluid loop between the condenser and the evaporator configured to pump circulating fluid in the liquid state to the evaporator.

2. The system according to claim 1, further comprising:
an underground well bore;
wherein the pump is arranged substantially at the bottom of the underground well bore.

3. The system according to claim 2, wherein the evaporator is arranged above ground outside of the underground well bore.

4. The system according to claim 3, wherein the fluid loop piping comprises:
one or more upward flowing pipes in the underground well bore delivering fluid from the pump, and
one or more downward flowing pipes in the underground well bore receiving the vapor from the evaporator.

5. The system according to claim 4, wherein the condenser is formed by the one or more downward flowing pipes in the underground well bore, wherein the vapor releases heat to the ground around the underground well bore and condenses into the liquid state.

6. The system according to claim 5, further comprising a fluid reservoir at the bottom of the underground well bore configured to receive the fluid in the liquid state.

7. The system according to claim 1, further comprising an incoming air flow provided to the evaporator, wherein the evaporator is configured to absorb heat from the incoming air flow and provide a cooler, outgoing air flow.

8. The system according to claim 7, further comprising an air conditioning system evaporator;
wherein the evaporator is positioned in between the air conditioning system evaporator and the incoming air flow to the air conditioning system evaporator; and
wherein the evaporator is configured to provide the cooler outgoing air flow to the air conditioning system evaporator.

9. The system according to claim 7, further comprising an air conditioning system condenser;
wherein the evaporator is positioned in between the air conditioning system condenser and the incoming air flow to the air conditioning system condenser; and
wherein the evaporator is configured to provide the cooler outgoing air flow to the air conditioning system condenser.

10. The system according to claim 1, further comprising a flow control valve positioned in the fluid loop in between the pump and the evaporator configured to control flow of the fluid in the liquid state to the evaporator.

11. The system according to claim 1, further comprising a compressor positioned in the fluid loop in a flow path from the evaporator and the condenser.

12. The system according to claim 11, wherein the compressor is arranged above ground outside of the underground well bore.

13. The system according to claim 11, wherein the compressor is configured to be turned on or off to alternate between operation modes using the compressor and not using the compressor.

14. (canceled)

15. The system according to claim 1, further comprising an underground well bore, wherein the condenser is arranged above ground outside of the underground well bore.

16. The system according to claim 15, wherein the fluid loop piping comprises:
one or more upward flowing pipes in the underground well bore delivering vapor to the condenser, and
one or more downward flowing pipes in the underground well bore receiving the fluid from the condenser.

17. The system according to claim 16, wherein the evaporator is formed by the one or more downward flowing pipes in the underground well bore, wherein the fluid absorbs heat from the ground around the underground well bore and evaporates into vapor.

18. The system according to claim 17, further comprising an incoming air flow provided to the condenser, wherein the condenser is configured to release heat to the incoming air flow and provide a warmer, outgoing air flow.

19. The system according to claim 18, further comprising a heating system condenser;
wherein the condenser is positioned in between the heating system condenser and the incoming air flow to the heating system condenser; and
wherein the condenser is configured to provide the warmer outgoing air flow to the heating system condenser.

20. The system according to claim 18, further comprising a heating system evaporator;
wherein the condenser is positioned in between the heating system evaporator and the incoming air flow to heating system evaporator; and
wherein the condenser is configured to provide the warmer outgoing air flow to the heating system evaporator.

21. The system according to claim 1, wherein the fluid is R32 refrigerant.

22. (canceled)
